(19) United States
(12) Patent Application Publication
(10) Pub. No.: US 2017/0180539 A1
(43) Pub. Date: Jun. 22, 2017

(54) Back Channel Authentication Using Smartphones

(71) Applicant: Stanley Security Solutions, Inc., Indianapolis, IN (US)

(72) Inventor: Walter P. PAYACK, JR., Indianapolis, IN (US)

(21) Appl. No.: 15/383,952

(22) Filed: Dec. 19, 2016

Related U.S. Application Data
(60) Provisional application No. 62/268,805, filed on Dec. 17, 2015.

(51) Int. Cl. H04M 1/725; H04W 12/06; H04W 12/08

(52) U.S. Cl. CPC H04M 1/72533; H04W 12/08; H04W 12/06

(57) ABSTRACT

Electronic Locks used for physical access control will be able to wirelessly communicate directly with smartphone for selectable multi-factor authentication using technology and components built into Smartphones. Systems and methods utilize the phone's digital credential function, the phone's screen unlock keypad function, and the phone's biometric template information and comparison function to establish authentication parameters in order to unlock the door.

This patent application claims priority to U.S. Provisional Patent Application No. 62/268,805, filed Dec. 17, 2015, which is hereby incorporated by reference in its entirety.

### I. FIELD OF THE INVENTION

The present invention relates to access management and control to locks using personal devices, such as smartphones or smart watches. More specifically, the invention is a system and methods for granting access to a plurality of locks in a number of physical structures using token identification. The system and methods are connected to or based on a number of different types of wireless networks for accessing locks using a smartphone.

### II. BACKGROUND OF THE INVENTION

Smartphones are becoming ubiquitous in our daily lives; we depend on them today, and it is expected that more elements of our daily lives will require a Smartphone in the future. It is foreseeable that your Smartphone will be used as one of a user's main credentials for access control, for all network logging in, for all encrypted messaging, for all payments, office automation, home automation etc.

Access Control is focused on making sure that only designated people have access to certain areas. For many years, mechanical keys were used as single factor access control; but these could be stolen or lent and used by other people. Technology replaced the mechanical key with an electronic card, but it still could be used by unauthorized people to gain access. Keypads were added to the system, prompting the user for a PIN or Passcode in combination with the electronic card.

When using Smartphones for access control, there will be no cards or badges to issue, fewer lost cards or keys to replace as people seldom lose their phones or forget to carry them with them. Stolen or lost phones can be removed quickly and easily from the database, minimizing the opportunity for unauthorized people to gain access.

The current state of art for wireless locks do not utilize selectable multi-factor authentication methods utilizing the smartphone's hardware and infrastructure. There are remote control methods for access management. For example, U.S. Pat. No. 6,675,300 discloses a remote controller that can perform remote control of a personal computer. The remote controller has a unique identifier and the PC to be controlled also has the same identifier stored therein. The remote controller and the computer may communicate by infrared (IR) or radio frequency (RF) signals. The identifier is provided for a security function. The computer checks whether the remote controller's identifier matches its own. If there is a match, the remote controller can be used to issue remote control commands to the computer. Signals from other remote controllers are ignored.

Notwithstanding the usefulness of the above-described methods, a need still exists for to provide smartphone access to locks without access cards or keys and other access control components. Thus, a back channel authentication system using smartphones addressing the aforementioned need is desired.

### III. SUMMARY OF THE INVENTION

This invention relates generally to access control systems and smartphone authentication. In at least one embodiment the invention includes a method for operating an access control system, the method comprising detecting by at least one lock at least one digital credential corresponding to at least one device, determining by at least one processor the number of digital credentials required for the at least one lock, determining by at least on database whether the detected at least one digital credential corresponds to at least one corresponding digital credential stored in a said database, detecting by the at least one lock the determined status of at least one corresponding detected at least one digital certificate, and when determined there is at least one corresponding at least one digital credential granting access to the at least one lock based on the determined status of the detected at least one digital credential.

In another embodiment, the invention includes an electronic access control system, comprising at least one device, the at least one device configured for access to at least one lock, a plurality of digital credentials corresponding to the at least one device, wherein the plurality of digital credentials is configured to be paired with a corresponding lock, one or more locks, wherein the one or more locks detects a plurality of digital credentials associated with the at least one of the plurality of devices, and wherein the one or more locks has a corresponding digital profile to determine the number of digital credentials required, and at least one processor, wherein the at least one processor communicates to at least one database to determine whether the plurality of digital credentials associated with the at least one device correspond to a plurality of digital credentials stored in said database.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes physical, whether direct or indirect, affixed or adjustably mounted, as for example, the radio is operatively connected to the lock. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

Given the following enabling description of the drawings, the apparatus should become evident to a person of ordinary skill in the art.

### IV. BRIEF DESCRIPTION OF THE DRAWINGS

FIG. 1 is a schematic illustration of a network according to the present invention.

FIG. 2 is a block diagram illustrating an embodiment of a general electronic access system using a smartphone to access a lock, according to the present invention.

FIG. 3 is a flowchart of an embodiment illustrating a method for authentication using a smart phone, according to the present invention.

Similar references and descriptions denote corresponding features of an electronic access control system are shown consistently throughout the attached drawings.

### V. DETAILED DESCRIPTION OF THE DRAWINGS

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

This description is illustrative of the embodiments of the present invention only and not intended to be limiting. The present invention is not limited, however, by the form of wireless signal transmission or any particular communication protocol. The back channel authentication system using a smartphone can include a system, smartphone, smartwatch or device connected to a local area network (LAN), a wide area network (WAN), internet, intranet, through Bluetooth® radio, radio frequency (RF), Bluetooth packets, repeaters, etc., and capable of exchanging data with and retrieving data therefrom, for example. To simplify discussion and to allow comparison between figures, like elements are assigned like reference numerals.

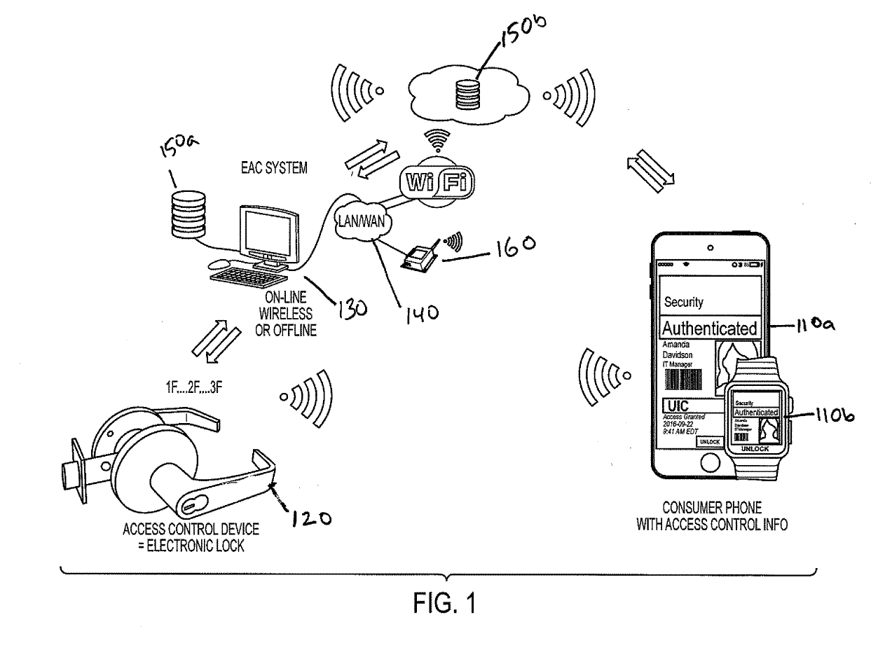

With reference now to the drawings, in particular to FIGS. 1-3, thereof, systems and methods embodying features, principles, and concepts of various exemplary embodiments of a back channel authentication system using smartphones will be described.

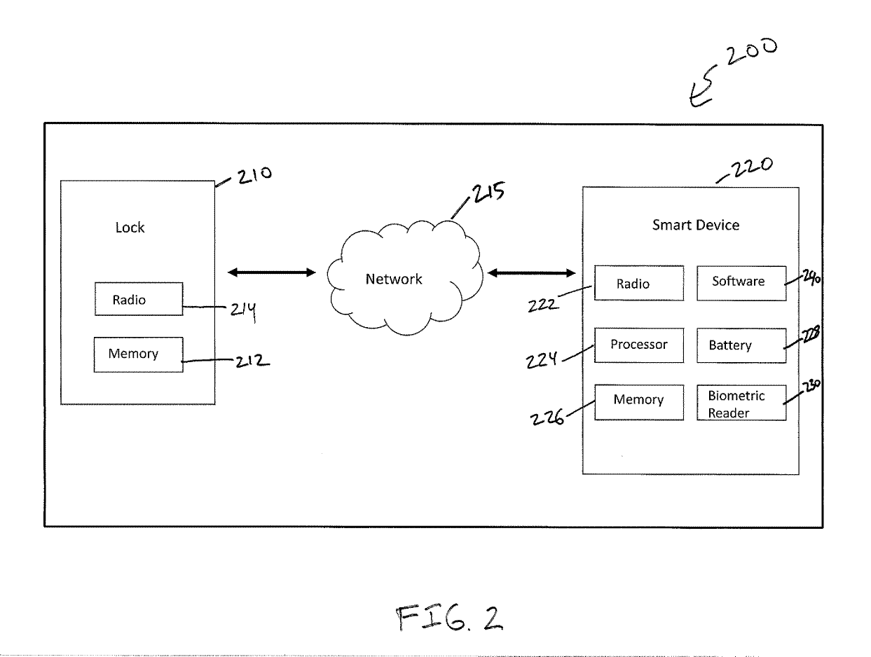

Referring now to FIG. 1, there is illustrated a block diagram illustrating a general access control environment 100 that can be utilized to implement embodiments of systems and methods for electronic access control with electronic locks using smartphones. The general access control environment 100 in FIG. 1 illustrates a system environment that includes a smartphone 110a and 110b, a lock 120, an electric access control system 130, a network 140, a database 150a and 150b, and a repeater 160. The network 140 is illusory and can be the network of a LAN or WAN as shown in FIG. 2. Although this embodiment illustrates a wireless network, the network 140 is not limited in this regard and can be any type of network or communication structure, such as a local area network (LAN), a wide area network (WAN), internet, intranet, through Bluetooth® radio, radio frequency (RF), Bluetooth® packets, repeaters, etc., capable of exchanging data with and retrieving data therefrom, for example. The electronic access control system 140 can be various hardware (e.g. client and servers such as the head end system described above) and/or software (e.g., threads, processes, computing devices), and should not be construed in a limiting sense.

In this embodiment, the transmission can occur online or offline. Further, In one embodiment of the communication of FIG. 1 between the smartphone 110a and the lock 120, each time the smartphone 110a is presented to the lock 120, it establishes credentials and authentication and simultaneously uploads from the lock 120 the audit trail records and potential maintenance issues, such as low battery to the smartphone 110a. In this instance, the digital credentials are shown as 1F, 2F, and 3F such as for 1F for device ID, 2F for pin number and 3F for biometric information. At the conclusion of the authentication and access process the lock communicates to transmit and offload the lock's audit trail and maintenance information (bytes and kilobytes) such that this info can be merged into the electronic access control system master log without specific physical actions to collect it. This can also be done through the smartphone 110a, such an API, which is communicatively connected to the network.

FIG. 2 is a block diagram illustrating one embodiment of a general electronic access environment 200 using a smartphone to access a lock and includes a lock 210, a network 215, and a smart device 220. The smart device 220 can be a smartphone, smart watch or other computing device. The lock 210 includes a memory 212 and a radio 214. The radio 214 can be a Bluetooth® radio, a wireless scanner, a radio frequency identifier (RFID) or a near field communication (NFC) device to detect or transmit signals from or to a mobile device such as a smartphone. The smartphone can include a radio 222, a processor 224, a memory 226, a battery 228, a biometric reader 230, and a software 240, such as an application program interface (API). The radio 222 can be a Bluetooth® radio, a wireless scanner, a radio frequency identifier (RFID), a near field communication (NFC) device, or a cellular antenna to detect or transmit signals.

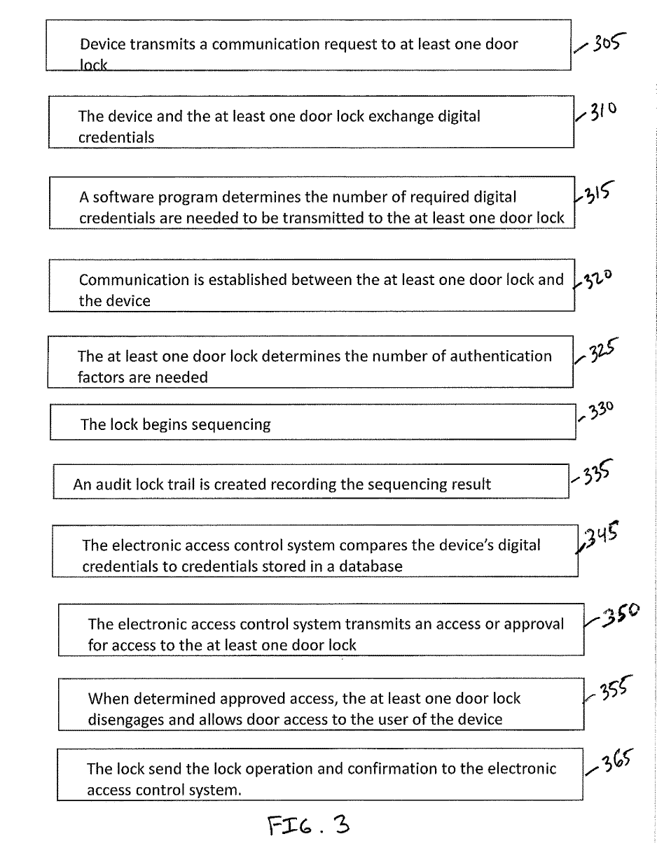

The software 240 can be any type of software suitable for authenticating the smartphone with the lock and is not limited in this regard. For example, in a communication later shown in FIG. 3, the smartphone can include an application programming interface (API) software designed for traffic management, authorization and access control, and monitoring. This is known in the art, available in the public domain, and will not be described here. The software used can be a GUI-based software program that is housed either directly on the smart phone, accessed online through a website, or through a cloud-based system. The software can include a head-end system as known in the art (not shown) that defines access control site and associated parameters. The access control system can be operated in an online or offline mode with direct communication between the smartphone and the lock or it can be remotely managed.

The smartphone device 220 can also include other computer-implemented devices, such as mobile computing devices (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, ultrabook™, etc.), e-readers (e.g., Kindle® by Amazon.com®, Nook® by Barnes and Nobles®, etc.), Global Positioning System (GPS)-based navigation systems, etc., and should not be construed in a limiting sense. The memory 226 can be any type of memory and is not limited in this regard. Examples of computer readable memory as can be used or included in the memory 226 can include a tangible, non-transitory computer readable storage medium such as a magnetic recording apparatus, an optical disk, a magneto-optical disk, flash disk, usb drives, and/or a semiconductor memory (for example, RAM, ROM, etc.). The lock 210 can include a memory for storing smartphone, access, and traffic data and is not limited in this regard. The lock 210 can include a processor (not shown) for determining smartphone authentication and access and is not limited in this regard.

The biometric reader 230 can be any type of sensory input, such as a fingerprint reader, and is not limited in this regard and can also be a voice recognition device, iris scanner, retinal scanner, facial recognition scanner, etc. (not shown). One embodiment of the biometric reader is known in the art for containing integrated technology that digitally manipulates the digital fingerprint scan via proprietary algorithms that determines based on a binary values for use with a smartphone and will not be discussed. The fingerprint template record can be made available through smart devices such as smartphones, online systems, wireless networked systems, and cloud systems can access it.

The smartphone device 220 can be connected to the door lock through a plurality of apparatus (not shown), such as a cellular radio, Wi-Fi radio, NFC radio, Bluetooth ® radio, or the like to communication with the lock 210. The network 215 can be any type of network, such as network 71. The communication can occur through any type of network, such as a local area network (LAN), a wide area network (WAN), internet, intranet, through Bluetooth® radio, radio frequency (RF), Bluetooth® packets, repeaters, etc., capable of exchanging data with and retrieving data therefrom.

The structure shown in FIG. 2 corresponds to access control generally. Access control is generally defined into a number of steps, such as step one having a key (e.g. digital credentials), a pin code, and a biometric authentication. For example, a university might state that classrooms only need single-factor authentication, e.g. an electronic key such as a smart card typically used in a hotel room. The same university can determine dorm rooms require 2-factor authentication, such as an electronic key and a pin code entered to grant access. Additionally, the university can also determine that research labs require 3-factor authentication, such as an electronic key, a pin code entered, and a biometric authentication of a user to grant access to the structure.

One of the first steps in order to access a lock, the user must first authenticate they have access to the corresponding facility. This access can be determined a number of ways. A user can bring a device, such as the smart device 220 to a lock, where, in close proximity (NFC or BLE), it can auto-initiate communication with the lock. The smartphone 240 and lock handshake (authentication data transmitted machine to machine) to exchange digital credential information. The credentials and parameters of the smart device 220 can be recorded into the lock or the electronic access control system. The electronic access control system can use any type of access and recordation methods to provide authentication such as requiring public key infrastructure (PKI) and issuing certificates for the smart device 220. The electronic access control system can track user access, facility location and associated parameters and store the data into a database. In an alternate embodiment, the smartphone device 220 can timestamp and export the digital representation template of the current fingerprint scan for storage or comparison via a corresponding record in a database or memory, such as the memory 226 locally or the database in FIG. 3 either locally or remotely.

Referring now to FIG. 3, there is illustrated is a flowchart of one embodiment of a method for accessing a lock using a smart phone, according to the present invention. At step 305, a device transmits a communication request to at least one door lock to initiate secure channel parameters. The device can be a smartphone, smartwatch, key fob, or a physical apparatus configured to transmit digital credentials. At step 310, the device can transmit the communication request when the device is at a predetermined proximity (e.g. NFC or BLE range), such as 10 cm. At 310, radios in the device and the lock can exchange digital credentials. At step 315, a software program, such as an API in a smartphone, can determine the number of authentication factors or digital credentials are required to be transmitted to the lock. In at least one embodiment, the software application can automatically pop up, on the screen, such as detection from a NFC tag, indicating initiation of communication. At this step, the communication request can include a number of digital credentials such as device id, a security code, biometric information, or other hardware identifiers. At step 320, communication is established between the door lock and the device. At this step, a radio on the door lock and a radio on the device transmit back and forth through handshake authentication to find a compatible channel between the device and the lock.

At step 325 and after a channel has been established between the device and the lock, the lock determines the number or type of authentication factors are required. At this step, the lock determines the number of authentication factors based on the location or profile established for the lock, such as a lock in a classroom setting may require only one credential of a device id but a lock in a dorm setting may require three credentials of a device id, security code, and biometric information. For example, in the instance where the lock requires only a single authentication factor, the lock can receive the device's id for matching credentials without user input. In the instance, where the lock requires two factors, the lock can request a user to input and transmit a pin number in addition to the received device id. In the instance the lock requires three authentication factors, the lock can request a user to input and transmit a pin number and place on a finger on a fingerprint reader on the device in addition to the received device ID. Although authentication factors have been described, the invention is not limited in this regard but the authentication can be used such as a geometric pattern, for example. Furthermore, the authentication factors can be a biometric authentication as a sole factor, a pin number as a sole factor, the smartphone as a sole factor any a number of combinations thereof.

At step 330, the lock can begin sequencing actions. If the lock profile requires multiple authentication factors or digital credentials, the lock can broadcast a request to the device to request a user to input additional information, such as biometric that can include placing a registered finger on a fingerprint scanner on the transmitting device and sending the biometric information to the lock. The biometric information can be stored on the phone in a secure element, such as an API, that requests the smartphone to internally compare the presented finger against an original enrolled fingerprint and output a flag, such as a green flag for fingerprint comparison matches or a red flag for fingerprint comparison does not match. If the biometric information matches the biometric information associated with a profile on the lock, the device, such as a smartphone, will send a signal indicating acceptance match. If the biometric information does not match the biometric information associated with the profile on the lock, the device will send a signal indicating non-acceptance, cancel the transaction request and suspend all further communications with the lock. The smartphone then transmits the comparison result or flag to the lock.

At step 335, an audit lock record is created recording the communication result of step 330. At step 340 and the digital credentials are determined a match, the authorization process initiates. At this step, the lock generates a transaction to request authorization approval from an electronic access control system. The authorization request can include at least one authentication factor. The authorization request can be include a token provided by the lock to mask the device's digital credentials.

At step 345, the electronic access control system can compare the device credentials to credentials stored in a database that is communicatively connected to the electronic access control system. At step 350 the electronic access control system transmits either an access approval or an access denial for access to the lock. At step 355 and when determined approved access, a latch bolt in the lock disengages and allows access to the user of the device. At step 360 and when determined denied access, the lock remains in the current locked state. At step 365 the lock sends the lock operation and confirmation to electronic access control system. At this step, the lock can also send the lock operation to the device.

In at least one embodiment, the system can include battery, non-wired power source. In at least one other embodiment, the system can be operated over wired or wireless networks. The data transmitted over a network, such as a wireless network, to operate the system can include data transmission through Wi-Fi network, cellular network, Bluetooth ®, near field communication (NFC), local area network (LAN), a wide area network (WAN), internet, intranet, extranet, virtual private network, through Bluetooth® radio, radio frequency (RF), Bluetooth® packets, repeaters, etc., and or communication protocol capable of exchanging data with and retrieving data therefrom, for example.

Processes, flowchart, steps, block diagrams, and processes in the Figures or Attachments illustrate the architecture, functionality, and operation of possible implementations of systems, methods and/or computer program products according to various embodiments of the present invention.

The present invention relates to access control management for computing devices such as a smartphone device. It can also use a key fob or another type of mobile device. It takes a new, convenient and secure approach to allowing access to a lock, such as a door lock, without requiring the convention key or smartcard. Only when a wireless identifier key, such as a public key identifier (PKI), carried by the authorized user on a smartphone is brought into the space of the door, the look will unlock and allows access to this user.

The information and operations that are transmitted throughout the various embodiments of systems and the methods for electronic access control system with electronic locks using smartphones can be in the form of electronic data, wireless signals, or a variation thereof, for example. The information and operations that are transmitted throughout the various embodiments can be sent wirelessly, optically, or by various types or arrangements of hard wire connections, or combinations thereof, among the various system components, for example.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying figures and attachments illustrate exemplary embodiments of the invention.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

We claim:

1. A method for operating an access control system, the method comprising:
detecting by at least one lock at least one digital credential corresponding to at least one device;
determining by at least one processor the number of digital credentials required for the at least one lock;
determining by at least on database whether the detected at least one digital credential corresponds to at least one corresponding digital credential stored in a said database;
detecting by the at least one lock the determined status of at least one corresponding detected at least one digital certificate; and
when determined there is at least one corresponding at least one digital credential granting access to the at least one lock based on the determined status of the detected at least one digital credential.

2. The method of claim 1, wherein the at least one device is one of a smartphone, srnartwatch, key fob, or mobile computing device.

3. The method of claim 1, further comprising transmitting wireless signals by at least one radio of at least one digital certificate.

4. The method of claim 1, further comprising determining by the at least one processor the number of authorized devices corresponding to at least one lock.

5. The method of claim 1, further comprising, detecting by the at least one processor notification of a plurality of determined unauthorized credentials.

6. An electronic access control system, comprising:
at least one device, the at least one device configured for access to at least one lock;
a plurality of digital credentials corresponding to the at least one device, wherein the plurality of digital credentials is configured to be paired with a corresponding lock;
one or more locks, wherein the one or more locks detects a plurality of digital credentials associated with the at least one of the plurality of devices, and wherein the one or more locks has a corresponding digital profile to determine the number of digital credentials required; and
at least one processor, wherein the at least one processor communicates to at least one database to determine whether the plurality of digital credentials associated with the at least one device correspond to a plurality of digital credentials stored in said database.

7. The electronic access control system of claim 6, further comprising at least one radio, wherein the at least one radio transmits wireless signals corresponding to at least one digital certificate.

8. The electronic access control system of claim 6, wherein the at least one device is one of a smartphone, smartwatch, or computing device.

9. The electronic access control system of claim 8, wherein the at least one processor is associated with at least one smartphone.

10. The electronic access control system of claim 8, wherein the at least one smartphone further comprises a biometric reader.

11. The electronic access control system of claim 6, further comprising the at least one processor concurrently receiving a plurality of authentications corresponding to at least one smartphone.
